(19) United States
(12) Patent Application Publication
(10) Pub. No.: US 2011/0143196 A1
(43) Pub. Date: Jun. 16, 2011

(54) LITHIUM SECONDARY BATTERY

(75) Inventors: Takefumi OKUMURA, Hitachinaka (JP); Ryo Inoue, Hitachinaka (JP); Toshio Haba, Tokai (JP); Chieko Araki, Hitachi (JP)

(73) Assignee: Hitachi Vehicle Energy, Ltd.

(21) Appl. No.: 12/961,693

(22) Filed: Dec. 7, 2010

(30) Foreign Application Priority Data
Dec. 10, 2009 (JP) 2009-280008

(51) Int. Cl. H01M 10/02

(52) U.S. Cl. 429/203

(57) ABSTRACT

Objects of the present invention are to improve the adhesion and processing characteristics of electrode composite layers and to provide a lithium secondary battery by which a decrease in battery capacity during high-temperature storage at 50° C. or higher is suppressed. The lithium secondary battery of the present invention comprises a positive electrode capable of storing and releasing lithium ions, a negative electrode capable of storing and releasing lithium ions, a separator disposed between the positive electrode and the negative electrode, and an electrolyte, wherein the negative electrode or the electrolyte contains a nonvolatile liquid.

### BACKGROUND OF THE INVENTION

1. Field of the Invention

The present invention relates to a lithium secondary battery.

2. Description of Related Art

In view of environmental conservation and energy conservation, hybrid vehicles in which the engine and the motor are used in combination as a power source are being developed and commercialized. Also, hybrid vehicles equipped with fuel batteries that are used instead of engines will be increasingly developed.

A secondary battery capable of repeatedly charging and discharging electricity represents an essential technology as an energy source for such hybrid vehicles.

In particular, the lithium secondary battery has characteristics such as high operating voltage and high energy density that enable high output. Hence, importance of the lithium secondary battery as a source of electricity for hybrid vehicles in the future is further increasing.

The lithium secondary battery is produced using a lithium composite metal oxide material as a positive electrode active material and a carbon material as a negative electrode active material.

The positive and negative electrode plates of the lithium secondary battery are produced by mixing such active materials with a binder resin composition (binder resin solution (organic solvent such as N-methyl-2-pyrrolidone or water)) to prepare a slurry, coating a metal foil that is a current collector with the slurry, drying the film, and then performing compression molding using a roller press or the like.

Mainly polyvinylidene fluoride (PVDF) is frequently used as such binder.

However, a PVDF binder has low adhesion between composite layers. This is a great practical problem in that during high-temperature storage at 50° C. or higher (which is required for a hybrid vehicle power source), problems occur due to lowered adhesion, such as active material going missing from and peeling off of a composite layer from a current collector, inducing low battery capacity.

To address such problems, JP Patent Publication (Kokai) No. 6-093025 A (1994) proposes a silane-denatured vinylidene fluoride-based polymer and JP Patent Publication (Kokai) No. 6-172452 A (1994) proposes vinylidene fluoride polymers having adhesive functional groups such as vinylidene fluoride-based polymers containing carboxyl groups or carbonate groups.

Also, JP Patent Publication (Kokai) No. 9-289023 A (1997) proposes improvement in adhesion as a result of improving swelling resistance to electrolytes using an ultrahigh-molecular-weight vinylidene fluoride polymer.

### SUMMARY OF THE INVENTION

As described above, good balance should be achieved between adhesion and processing characteristics of electrode composite layers in order to use a conventionally proposed PVDF.

Specifically, an object of the present invention is to improve both adhesion and processing characteristics of electrode composite layers and thus to provide a lithium secondary battery by which a decrease in battery capacity during high-temperature storage at 50° C. or higher is suppressed.

The present invention relates to a lithium secondary battery comprising a positive electrode capable of storing and releasing lithium ions, a negative electrode capable of storing and releasing lithium ions, a separator disposed between the positive electrode and the negative electrode, and an electrolyte, wherein the negative electrode or/and electrolyte contain a nonvolatile liquid.

A nonvolatile liquid is a component for imparting flexibility to a negative electrode.

In particular, upon production of a negative electrode, it is preferable to mix a nonvolatile liquid with a slurry when a negative electrode active material is mixed with a binder resin composition (binder resin solution (organic solvent such as N-methyl-2-pyrrolidone or water)), followed by coating of a metal foil (which is a current collector) with the slurry and then drying (crystallization of binder resin) the foil.

In addition, a compound that is a nonvolatile liquid is preferably a compound represented by Chemical formula 1, which is an ionic liquid.

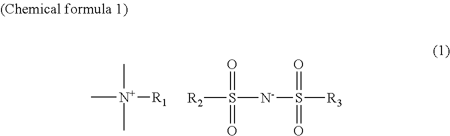

(wherein R₁ denotes a C₁₋₁₀ alkyl group, R₂ denotes a fluorinated C₁₋₂ alkyl group, and R₃ denotes a fluorinated C₁₋₂ alkyl group.)

Also, a compound that is a nonvolatile liquid is preferably a compound represented by Chemical formula 2, which is an ionic liquid.

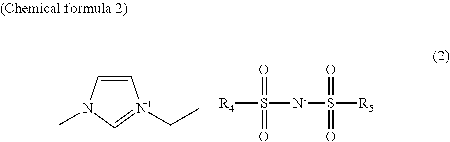

(wherein R₄ denotes a fluorinated C₁₋₂ alkyl group and R₅ denotes a fluorinated C₁₋₂ alkyl group.)

The ionic liquid represented by Chemical formula 1 or 2 is prepared by mixing a component having positive (+) polarity with a component having negative (−) polarity.

In addition, the positive electrode has a positive electrode composite and a positive electrode current collector. Here, the term “positive electrode composite layer” refers to a composite layer that is formed by coating a positive electrode current collector with a positive electrode composite containing a positive electrode active material, an electronically conductive material, and a binder.

Also, the negative electrode has a negative electrode composite and a negative electrode current collector. Here, the term “negative electrode composite layer” refers to a composite layer formed by coating a negative electrode current collector with a negative electrode composite containing a negative electrode active material, an electronically conductive material, and a binder.

According to the present invention, a lithium secondary battery can be provided, by which both adhesion and processing characteristics of an electrode composite layer can be improved and a decrease in battery capacity during high-temperature storage at 50° C. or higher can be suppressed.

### BRIEF DESCRIPTION OF THE DRAWING

FIG. 1 is a sectional view showing an outline of a lithium secondary battery.

### DETAILED DESCRIPTION OF THE PREFERRED EMBODIMENTS

A lithium secondary battery that is described in the Examples comprises a positive electrode capable of storing and releasing lithium ions, a negative electrode capable of storing and releasing lithium ions, a separator disposed between the positive electrode and the negative electrode, and an electrolyte.

The lithium secondary battery is characterized in that the negative electrode or/and electrolyte contain a nonvolatile liquid.

In particular, upon production of a negative electrode, it is preferable to mix a nonvolatile liquid with a slurry, to coat a metal foil (that is a current collector) with the slurry, and then to dry (crystallization of the binder resin) the foil when a negative electrode active material is mixed with a binder resin composition (binder resin solution (organic solvent such as N-methyl-2-pyrrolidone or water)).

In addition, a compound that is a nonvolatile liquid is represented by Chemical formula 1.

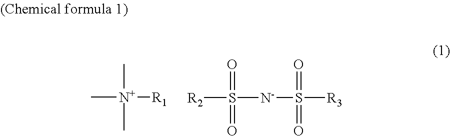

(wherein R₁ denotes a C₁₋₁₀ alkyl group, R₂ denotes a fluorinated C₁₋₂ alkyl group, and R₃ denotes a fluorinated C₁₋₂ alkyl group.)

Also, a compound that is a nonvolatile liquid is represented by Chemical formula 2.

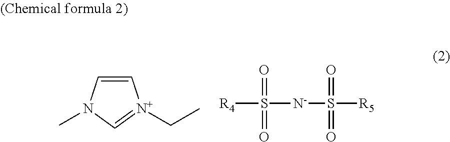

(wherein R₄ denotes a fluorinated C₁₋₂ alkyl group and R₅ denotes a fluorinated C₁₋₂ alkyl group.)

As a compound represented by Chemical formula 1, trimethyl propylammonium-bis(trifluoromethanesulfonyl)imide, trimethyl butylammonium-bis(trifluoromethanesulfonyl)imide, trimethyl pentylammonium-bis(trifluoromethanesulfonyl)imide, trimethyl hexylammonium-bis(trifluoromethanesulfonyl)imide, trimethyl octylammonium-bis(trifluoromethanesulfonyl)imide, or the like can be used.

In particular, trimethyl propylammonium-bis(trifluoromethanesulfonyl)imide is preferred, since a negative electrode prepared to contain trimethyl propylammonium-bis(trifluoromethanesulfonyl)imide makes it possible to improve the flexibility of the negative electrode, suppress a decrease in the initial output of the battery, and suppress deterioration during high-temperature storage at 50° C. or higher.

As a compound represented by Chemical formula 2, 1-ethyl-3-methylimidazolium-bis(trifluoromethanesulfonyl)imide, 1-ethyl-3-methylimidazolium-bis(pentafluoroethanesulfonyl)imide, or the like can be used.

In particular, 1-ethyl-3-methylimidazolium-bis(trifluoromethanesulfonyl)imide is preferred, since a negative electrode prepared to contain 1-ethyl-3-methylimidazolium-bis(trifluoromethanesulfonyl)imide makes it possible to improve the flexibility of the negative electrode, suppress a decrease in initial output of the battery, and suppress deterioration during high-temperature storage at 50° C. or higher.

Also, a compound represented by Chemical formula 1 and a compound represented by Chemical formula 2 may be mixed.

The content of the nonvolatile liquid preferably ranges from 0.1 wt % to 50 wt % with respect to the binder resin composition. A content of higher than 50 wt % is unfavorable since such content results in difficulties during preparation of the negative electrode. Also, the lower limit is the detection limit. More preferably, the content ranges from 0.1 wt % to 10 wt %.

Examples of a negative electrode active material that can be used herein include natural graphite, a composite carboneous material prepared by forming a coating on natural graphite by a dry CVD (Chemical Vapor Deposition) method or a wet spray method, artificial graphite produced by burning a resin such as epoxy or phenol as a raw material or a pitch-based material obtained from petroleum or coal as a raw material, a carboneous material such as an amorphous carbon material, or, a lithium metal that can store and release lithium by forming a compound with lithium, or an oxide or a nitride of an element of the fourth group, such as silicon, germanium, and tin, which can store and release lithium through the formation of a compound with lithium followed by insertion into intercrystalline space.

In addition, they may be generally referred to as “negative electrode active materials.”

In particular, a carboneous material is excellent in view of its high conductivity and low-temperature properties, as well as cycle stability. Among such carboneous materials, materials having wide carbon plane interlayer spacing (d₀₀₂) are preferred because of their ability to rapidly charge and discharge and good low-temperature properties. However, meanwhile, materials having wide d₀₀₂ may cause a decrease in capacity at initial charging or low charge-discharge efficiency. Hence, their d₀₀₂ is preferably 0.39 nm or less. Such carboneous materials may be referred to as forms of “pseudo anisotropic carbon.”

Furthermore, when an electrode is constructed, a carboneous material having high conductivity properties may be mixed with the electrode, such as graphite, amorphous, and active carbon materials.

Also, as a graphite material, a material having the following characteristics (1) to (3) maybe used.

(1) R (I_{D}/I_{G}) represents the intensity ratio of peak intensity (I_{D}) within a range of 1300 cm⁻¹-1400 cm⁻¹ as measured by Raman spectroscopy to peak intensity (I_{G}) within a range of 1580 cm⁻¹-1620 cm⁻¹ as measured by Raman spectroscopy is 0.2 or more and 0.4 or less.
(2) Peak half width Δ within a range of 1300 cm⁻¹-1400 cm⁻¹ as measured by Raman spectroscopy is 40 cm⁻¹ or more and 100 cm⁻¹ or less.
(3) Intensity ratio X (I₍₁₁₀₎I₍₀₀₄₎) of the peak intensity (I₍₁₁₀₎) of surface (110) to the peak intensity (I₍₀₀₄₎) of surface (004) as a result of X-ray diffraction is 0.1 or more and 0.45 or less.

Also, because of reduction in electronic resistance, a conducting agent may further be added to the negative electrode composite layer.

Examples of a conducting agent include carbon materials such as carbon black, graphite, carbon fiber, and metal carbide. These materials may be used independently or used in combination by mixing them.

A binder resin constructing a binder resin composition may be any binder resin that can cause adhesion between a material constructing a negative electrode and a current collector for negative electrodes. Examples of such binder resin include homopolymers such as vinylidene fluoride, tetrafluoroethylene, acrylonitrile, and ethylene oxide or copolymers thereof, and styrene-butadiene rubber.

As a solvent constituting a binder resin solution, N-methyl-2-pyrrolidone, N,N-dimethylformamide, N,N-dimethylacetamide, dimethylsulfoxide, hexamethylphosphoamide, dioxane, tetrahydrofuran, tetramethylurea, triethylphosphate, trimethylphosphate, or the like can be used.

In particular, nitrogen-containing organic solvents such as N-methyl-2-pyrrolidone, N,N-dimethylformamide, and N,N-dimethylacetamide are preferable because of their high solubility for binder resins.

Also, these solvents may be used independently or mixed and then used.

As a current collector for negative electrodes, a metal foil, metal mesh, or the like such as stainless steel, copper, nickel, and titanium can be used. In particular, copper is preferred and zirconia or zinc-containing copper having high thermostability is preferred.

Under preferred conditions for drying negative electrodes, a solvent constituting a binder resin solution is evaporated, at a temperature that is the same as or higher than the crystallization temperature for a binder resin. The conditions depend on binder types or solvent types. For example, in the case of PVDF, 150° C. is preferred.

A positive electrode is formed by applying a positive electrode composite layer composed of a positive electrode active material, an electronically conductive material, and a binder onto an aluminium foil that is a current collector.

Also, for reduction of electronic resistance, a conducting agent may be added to a positive electrode composite layer.

As a positive electrode active material, a lithium composite oxide represented by composition formula Li_{α}MnₓM1_{y}M2_{z}O₂ (wherein M1 is at least one type selected from Co and Ni, M2 is at least one type selected from Co, Ni, Al, B, Fe, Mg, and Cr, and x+y+z=1, 0<α<1.2, 0.2≦x≦0.6, 0.2≦y≦0.4, 0.05≦z≦0.4) is preferred.

Also, it is particularly more preferred that M1 is Ni or Co, M2 is Co or Ni. A further preferred formula is LiMn_{1/3}Ni_{1/3}CO_{1/3}O₂.

In the composition, when Ni is increased, the capacity can be increased, when Co is increased, output at a low temperature can be improved, and when Mn is increased, material cost can be suppressed.

Also, an addition element has effects of stabilizing cycle characteristics.

Moreover, a symmetric rhombic phosphate compound in the space group Pmnb, which is represented by general formula LiMₓPO₄(M: Fe or Mn; 0.01≦X≦0.4) or general formula LiMn₁₋ₓMₓPO₄ (M: divalent cation other than Mn; 0.01≦X≦0.4), may also be used herein.

In particular, LiMn_{1/3}Ni_{1/3}CO_{1/3}O₂ is appropriate as a lithium battery material for hybrid vehicles (HEV) because of its good low-temperature properties and high cycle stability.

Any binder may be used herein, as long as it causes adhesion of a material used to construct a positive electrode to a current collector for positive electrodes. Examples of such binder include homopolymers such as vinylidene fluoride, tetrafluoroethylene, acrylonitrile, and ethylene oxide or copolymers thereof, and styrene-butadiene rubber.

Examples of a conducting agent include carbon materials such as carbon black, graphite, carbon fiber, and metal carbide. They may be used independently or mixed and then used.

An electrolyte is composed of at least one compound selected from the compound represented by Chemical formula 3, the compound represented by Chemical formula 4, the compound represented by Chemical formula 5, and the compound represented by Chemical formula 6, and a lithium salt.

Also, the compound represented by Chemical formula 1 and the compound represented by Chemical formula 2 flow away from the negative electrode to an electrolyte when the battery is used, and the electrolyte contains the compound represented by Chemical formula 1 and the compound represented by Chemical formula 2 as constituents.

The content of the compound represented by Chemical formula 1 and the compound represented by Chemical formula 2 in an electrolyte is preferably 50 wt % or less. A content of higher than 50 wt % is not preferable, since such content lowers the degree of ion conductivity of the electrolyte, resulting in lower battery output.

Also, further preferably, the content in an electrolyte ranges from 0.1 wt % to 10 wt %.

The compound is represented by Chemical formula 3

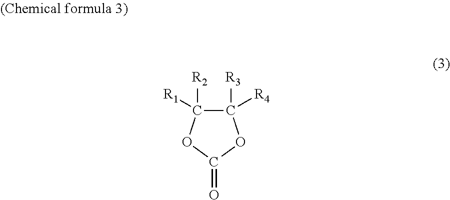

(wherein, R₁, R₂, R₃, and R₄ denote hydrogen, fluorine, chlorine, a C₁₋₃ alkyl group, or a fluorinated alkyl group).

The compound is represented by Chemical formula 4

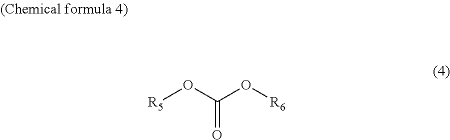

(wherein, R₅ and R₆ denote hydrogen, fluorine, chlorine, a C₁₋₃ alkyl group, or a fluorinated alkyl group).

The compound is represented by Chemical formula 5

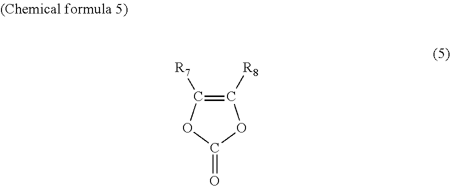

(wherein, R₇ and R₈ denote hydrogen, fluorine, chlorine, a C₁₋₃ alkyl group, or a fluorinated alkyl group).

The compound is represented by Chemical formula 6

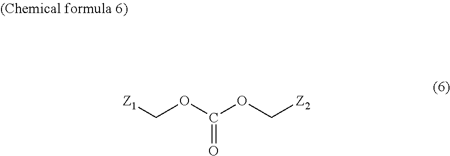

(wherein, Z₁ and Z₂ denote a vinyl group, an acryl group, or a methacryl group).

With respect to the total volume of a solvent for an electrolyte composed of the compound represented by Chemical formula 3, the compound represented by Chemical formula 4, the compound represented by Chemical formula 5, and the compound represented by Chemical formula 6, the compositional proportion of the compound represented by Chemical formula 3 ranges from 18.0 vol % to 30.0 vol %, the compositional proportion of the compound represented by Chemical formula 4 ranges from 74.0 vol % to 81.8 vol %, and the compositional proportion of the compound represented by Chemical formula 5 or 6 ranges from 0.1 vol % to 1.0 vol %. A compositional proportion of the compound represented by Chemical formula 5 or 6 of 1.0 vol % or more is not preferable, since the internal resistance of the battery is increased to result in lower battery output.

Examples of the compound represented by Chemical formula 3, which can be used herein, include ethylene carbonate (EC), trifluoropropylene carbonate (TFPC), chloroethylene carbonate (ClEC), fluoroethylene carbonate (FEC), trifluoroethylene carbonate (TFEC), difluoroethylene carbonate (DFEC), and vinyl ethylene carbonate (VEC). In particular, EC is preferably used in view of formation of a coating film on a negative electrode.

Also, addition of a small amount (2 vol % or less) of ClEC, FEC, TFEC, or VEC is involved in formation of an electrode coating film and provides good cycle characteristics.

Furthermore, TFPC or DFEC may be added in a small amount (2 vol % or less) in view of formation of a coating film on a positive electrode.

As the compound represented by Chemical formula 4, dimethylcarbonate (DMC), ethylmethylcarbonate (EMC), diethylcarbonate (DEC), methylpropylcarbonate (MPC), ethylpropylcarbonate (EPC), trifluoromethylethylcarbonate (TFMEC), 1,1,1-trifluoroethylmethylcarbonate (TFEMC), or the like can be used.

DMC is a solvent with high compatibility, which is appropriately used by mixing with EC or the like.

DEC has a melting point lower than that of DMC, which is appropriate for low-temperature (−30° C.) properties.

EMC has asymmetric molecular structure and a low melting point, which is appropriate for low-temperature properties.

EPC and TFMEC have propylene side chains and asymmetric molecular structures, so that they are appropriate as solvents for adjusting low-temperature properties. In particular, TFEMC has an increased dipole moment since a part of the molecule is fluorinated, so that TFEMC is appropriate for maintaining the dissociation properties of a lithium salt at a low temperature and thus is appropriate for low-temperature properties.

As the compound represented by Chemical formula 5, vinylene carbonate (VC), methylvinylene carbonate (MVC), dimethylvinylene carbonate (DMVC), ethylvinylene carbonate (EVC), diethylvinylene carbonate (DEVC), or the like can be used.

VC has a low molecular weight, so that VC is thought to form a fine electrode coating film.

MVC, DMVC, EVC, DEVC, or the like prepared by substitution with an alkyl group in VC is thought to form a low-density electrode coating film in accordance with alkyl chain size. MVC, DMVC, EVC, DEVC, or the like is thought to effectively act to improve low-temperature properties.

An example of the compound represented by Chemical formula 6 is dimethacryl carbonate (DMAC).

Examples of lithium salts to be used for electrolytes are not particularly limited and include inorganic lithium salts such as LiPF₆, LiBF₄, LiClO₄, LiI, LiCl, and LiBr and organic lithium salts such as LiB[OCOCF₃]₄, LiB[OCOCF₂CF₃]₄, LiPF₄(CF₃)₂, LiN(SO₂CF₃)₂, and LiN(SO₂CF₂CF₃)₂.

In particular, LiPF₆, which is used in many consumer batteries, is an appropriate material in terms of stability of quality. Also, LiB[OCOCF₃]₄ is an effective material since it exerts good dissociation properties, good solubility, and high conductivity at a low concentration.

As described above, a lithium secondary battery can be provided according to an embodiment of the present invention, which is capable of achieving a balance between adhesion and processing characteristics of an electrode composite layer and suppressing deterioration during high-temperature storage at 50° C. or higher. The lithium secondary battery can be broadly used as a power supply for hybrid vehicles and a power supply or a backup power supply for vehicle electric control systems that may be subjected to a high temperature such as 50° C. or higher. The lithium secondary battery is also appropriate as a power supply for industrial applications such as for railroads, electric power tools, and forklifts.

According to the embodiments, when a negative electrode is produced and specifically, when a negative electrode active material and a binder resin composition (binder resin solution (organic solvent such as N-methyl-2-pyrrolidone or water)) are mixed, a nonvolatile liquid is mixed with a slurry, a metal foil that is a current collector is coated with the slurry, and then the metal foil is dried (crystallization of binder resin). Thus, a negative electrode with sufficient flexibility can also be prepared while maintaining the adhesion of the electrode composite layer of the negative electrode. A lithium secondary battery can also be provided, by which deterioration during high-temperature storage at 50° C. or higher is suppressed.

Also, according to the embodiments, PVDF has high crystallinity and exhibits low degree of swelling in an electrolyte, so that PVDF can have sufficient effects for suppressing the decrease in battery capacity. Moreover, the embodiments do not increase the viscosity of a slurry and present no problem in terms of processing characteristics.

Hereafter, preferred embodiments for implementation of the present invention are as described below with reference to specific examples.

### Example 1

### Production of Wound-Type Lithium Secondary Battery

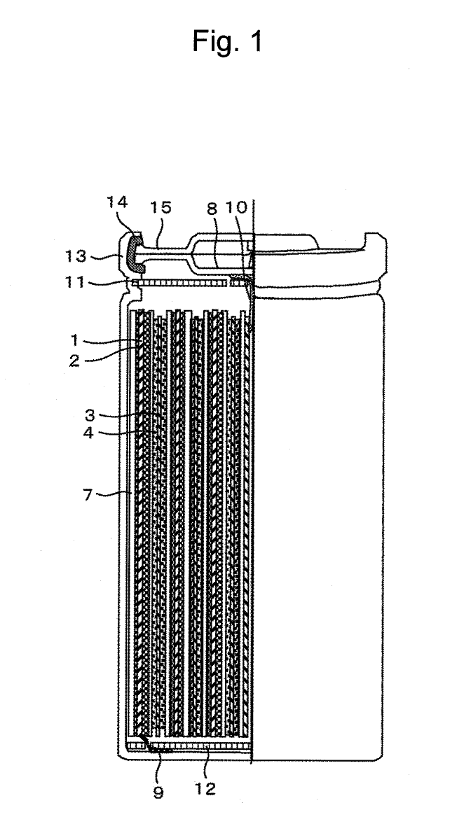

A wound-type battery of this Example was produced by a method described below. FIG. 1 is a sectional view showing the outline of a lithium secondary battery, and specifically, it is a sectional view showing one side of a wound-type lithium secondary battery.

First, a positive electrode material paste was prepared using LiMn_{1/3}Ni_{1/3}CO_{1/3}O₂ as a positive electrode active material, carbon black (CB1) and graphite (GF2) as electronically conductive materials, polyvinylidene fluoride (PVDF) as a binder, and NMP (N-methylpyrrolidone) as a solvent, so that the ratio of the weights of solid contents when dried was LiMn_{1/3}Ni_{1/3}CO_{1/3}O₂:CB1:GF2:PVDF=86:9:2:3.

An aluminium foil to be used as a positive electrode current collector 1 was coated with the positive electrode material paste, dried at 80° C., pressed using a pressure roller, and then dried at 120° C., so that a positive electrode composite layer 2 was formed on the positive electrode current collector 1.

Next, a negative electrode material slurry was prepared using amorphous pseudo anisotropic carbon as a negative electrode active material, carbon black (CB2) as an electronically conductive material, PVDF as a binder, trimethyl propylammonium-bis(trifluoromethanesulfonyl)imide (TMPA-TFSI) as a nonvolatile liquid, and NMP as a solvent, so that the ratio of the weights of the solid contents when dried was pseudo anisotropic carbon:CB2:PVDF:TMPA-TFSI=88:4:7:1.

A copper foil to be used as a negative electrode current collector 3 was coated with the negative electrode material slurry, subjected to primary drying at 80° C., subjected to secondary drying at 150° C., pressed using a pressure roller, and then dried at 150° C., so that a negative electrode composite layer 4 was formed on the negative electrode current collector 3.

An electrolyte was prepared by mixing a solvent at compositional (volume) ratio of EC:VC:DMAC:DMC:EMC=20:0.8:0.2:39.5:39.5 and then dissolving 1 M (mol) of LiPF₆ as a lithium salt.

A separator 7 was sandwiched in between the thus prepared electrodes so as to form a wound group, and then the resultant was inserted into a negative electrode battery can 13.

Subsequently, one end of a negative electrode lead 9 made of nickel was welded to the negative electrode current collector 3 and the other end was welded to the negative electrode battery can 13 for collecting electricity from the negative electrode.

Also, one end of a positive electrode lead 10 made of aluminum was welded to the positive electrode current collector 1 and the other end was welded to a circuit breaker valve 8 for collecting electricity from the positive electrode and then electrically connected via the circuit breaker valve 8 to a positive electrode battery can 15.

An electrolyte was further poured followed by fixing, so that a wound-type battery was prepared.

In addition, as shown in FIG. 1, “11” indicates a positive electrode insulator, “12” indicates a negative electrode insulator, and “14” indicates a gasket.

### (Evaluation of Flexibility of Negative Electrode)

A strip (width of 60 mm×length of 20 mm) was cut from the negative electrode in a glove box (dew point: −60° C. or lower). The negative electrode strip was wound around a stainless steel bar with a diameter of 4 mmφ, with the surface thereof (on which the composite layer had been formed) facing outward. Both ends were overlapped and then a 100-g weight was attached. This state was maintained for 1 minute. When no examples of poor appearance such as traces of cracks or corrugation were observed on the negative electrode surface, it was determined that the negative electrode had flexibility. When poor appearance was observed, it was determined that the negative electrode lacked flexibility.

Only batteries produced using negative electrodes that could be determined to have flexibility were subjected to evaluation of battery properties.

### (Evaluation of Battery Properties)

The Direct Current Resistance (DCR) and battery capacity of a wound-type lithium secondary battery at 25° C. shown in FIG. 1 were evaluated by techniques described below.

Evaluation was conducted twice (initially and after 30 days of storage at 65° C.), followed by relative comparison with the initial value.

### <Method for Evaluation of Direct Current Resistance>

The battery was charged with a constant current of 0.7 A to 4.1 V. The battery was charged with a constant voltage of 4.1 V until the current value reached 20 mA. After 30 minutes of non-operation, discharge was performed at 0.7 A to 2.7 V. This procedure was repeated 3 times.

Next, the battery was charged with a constant current of 0.7 A to 3.8 V. After 10 minutes of discharge at 10 A, the battery was charged again with a constant current to 3.8 V, discharged at 20 A for 10 minutes, charged again to 3.8 V, and then discharged at 30 A for 10 minutes.

The direct current resistance of the battery was evaluated based on the IV characteristics at this time. Table 1 shows the measurement results.

### <Method for Evaluation of Battery Capacity Upon Storage at 65° C.>

The battery was charged with a constant current of 0.7 A to 4.1 V and charged with a constant voltage of 4.1 V until the current value reached 20 mA. After 30 minutes of non-operation, discharge was performed at 0.7 A to 2.7 V. This procedure was repeated 3 times.

Next, the battery was charged with a constant current of 0.7 A to 4.1 V, left to stand for 30 minutes, placed in a 65° C. thermostat, and then left to stand for 30 days. Then voltage was measured. Table 1 shows the measurement results.

### Example 2

The battery was prepared and evaluated by a method similar to that in Example 1 except that trimethyl butylammonium-bis(trifluoromethanesulfonyl)imide (TMBA-TFSI) was used as a nonvolatile liquid. Table 1 shows the results.

### Example 3

The battery was prepared and evaluated by a method similar to that in Example 1 except that trimethyl pentylammonium-bis(trifluoromethanesulfonyl)imide (TMPeA-TFSI) was used as a nonvolatile liquid. Table 1 shows the results.

### Example 4

The battery was prepared and evaluated by a method similar to that in Example 1 except that trimethyl hexylammonium-bis(trifluoromethanesulfonyl)imide (TMHA-TFSI) was used as a nonvolatile liquid. Table 1 shows the results.

### Example 5

The battery was prepared and evaluated by a method similar to that in Example 1 except that trimethyl octylammonium-bis(trifluoromethanesulfonyl)imide (TMOA-TFSI) was used as a nonvolatile liquid. Table 1 shows the results.

### Example 6

The battery was prepared and evaluated by a method similar to that in Example 1 except that 1-ethyl-3-methylimidazolium-bis(trifluoromethanesulfonyl)imide (EMI-TFSI) was used as a nonvolatile liquid. Table 1 shows the results.

### Example 7

The battery was prepared and evaluated by a method similar to that in Example 1 except that 1-ethyl-3-methylimidazolium-bis(pentafluoroethanesulfonyl)imide (EMI-BETI) was used as a nonvolatile liquid. Table 1 shows the results.

### Comparative Example 1

The battery was prepared and evaluated by a method similar to that in Example 1 except that a negative electrode material slurry was prepared using NMP as a solvent so that the ratio of the weights of the solid contents when dried was pseudo anisotropic carbon:CB2:PVDF=88:4:8. Table 1 shows the results.

### Comparative Example 2

The battery was prepared and evaluated by a method similar to that in Example 1 except that the secondary drying temperature was determined to be 100° C. Table 1 shows the results.

### Comparative Example 3

The battery was prepared and evaluated by a method similar to that in Example 6 except that the secondary drying temperature was determined to be 100° C. Table 1 shows the results.

TABLE 1

| | | | | | | Rate of |
|---|---|---|---|---|---|---|
| | | | | | | increase in |
| | | | | | Capacity | direct |
| | | Secondary | | Nonvolatile | retention | current |
| | | drying | | liquid | rate @ | resistance |
| | Nonvolatile | temperature | | content in | day 30 | @ day 30 |
| | liquid | (° C.) | Flexibility | electrolyte | (%) | (%) |
| Example 1 | TMPA-TFSI | 150 | With | 10 wt % or | 92 | 109 |
| | | | flexibility | less | | |
| Example 2 | TMBA-TFSI | 150 | With | ↑ | 93 | 108 |
| | | | flexibility | | | |
| Example 3 | TMPeA-TFSI | 150 | With | ↑ | 94 | 106 |
| | | | flexibility | | | |
| Example 4 | TMHA-TFSI | 150 | With | ↑ | 92 | 109 |
| | | | flexibility | | | |
| Example 5 | TMOA-TFSI | 150 | With | ↑ | 91 | 110 |
| | | | flexibility | | | |
| Example 6 | EMI-TFSI | 150 | With | ↑ | 90 | 111 |
| | | | flexibility | | | |
| Example 7 | EMI-BETI | 150 | With | ↑ | 89 | 112 |
| | | | flexibility | | | |
| Comparative | — | 150 | No | — | — | — |
| example 1 | | | flexibility | | | |
| Comparative | TMPA-TFSI | 100 | With | 10 wt % or | 75 | 120 |
| example 2 | | | flexibility | less | | |
| Comparative | EMI-TFSI | 100 | With | ↑ | 77 | 125 |
| example 3 | | | flexibility | | | |

TMPA-TFSI trimethyl propylammonium-bis(trifluoromethanesulfonyl)imide
TMBA-TFSI trimethyl butylammonium-bis(trifluoromethanesulfonyl)imide
TMPeA-TFSI trimethyl pentylammonium-bis(trifluoromethanesulfonyl)imide
TMHA-TFSI trimethyl hexylammonium-bis(trifluoromethanesulfonyl)imide
TMOA-TFSI trimethyl octylammonium-bis(trifluoromethanesulfonyl)imide
EMI-TFSI 1-ethyl-3-methylimidazolium-bis(trifluoromethanesulfonyl)imide
EMI-BETI 1-ethyl-3-methylimidazolium-bis(pentafluoroethanesulfonyl)imide

The negative electrodes of Examples 1-7, in which nonvolatile liquids had been added to negative electrodes, had flexibility compared with the negative electrode of Comparative example 1 for which no mixing had been performed. Batteries can be prepared using the negative electrodes of Examples 1-7.

Also, the capacity retention rate and the rate of increase in direct current resistance were more improved in the case of the batteries of Examples 1 and 6 wherein nonvolatile liquids were added to negative electrodes and the secondary drying temperature was 150° C., compared with the batteries of Comparative examples 2 and 3 wherein the secondary drying temperature was 100° C.

### INDUSTRIAL APPLICABILITY

The lithium secondary battery of the present invention can be broadly used as a power supply for hybrid vehicles or a power supply or a backup power supply for vehicle electric control systems.

### EXPLANATION OF REFERENCE NUMERALS

1 Positive electrode current collector
2 Positive electrode composite layer
3 Negative electrode current collector
4 Negative electrode composite layer
7 Separator
8 Circuit breaker valve
9 Negative electrode lead
10 Positive electrode lead
11 Positive electrode insulator
12 Negative electrode insulator
13 Negative electrode battery can
14 Gasket
15 Positive electrode battery can

What is claimed is:

1. A lithium secondary battery, comprising a positive electrode capable of storing and releasing lithium ions, a negative electrode capable of storing and releasing lithium ions, a separator disposed between the positive electrode and the negative electrode, and an electrolyte, wherein the negative electrode or the electrolyte contains a nonvolatile liquid.

2. The lithium secondary battery according to claim 1, wherein the nonvolatile liquid is an ionic liquid.

3. The lithium secondary battery according to claim 1, wherein the nonvolatile liquid is a compound represented by Chemical formula 1, 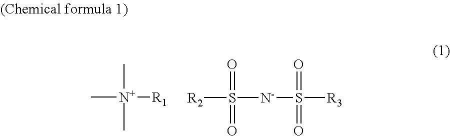
(wherein R₁ denotes a C₁₋₁₀ alkyl group, R₂ denotes a fluorinated C₁₋₂ alkyl group, and R₃ denotes a fluorinated C₁₋₂ alkyl group).

4. The lithium secondary battery according to claim 1, wherein the nonvolatile liquid is a compound represented by Chemical formula 2, 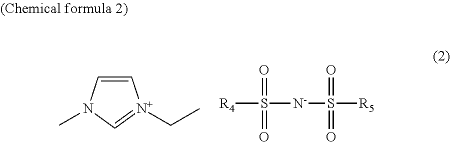
(wherein R₄ denotes a fluorinated C₁₋₂ alkyl group and R₅ denotes a fluorinated C₁₋₂ alkyl group).

5. The lithium secondary battery according to claim 1, wherein the nonvolatile liquid is trimethyl propylammonium-bis(trifluoromethanesulfonyl)imide, trimethyl butylammonium-bis(trifluoromethanesulfonyl)imide, trimethyl pentylammonium-bis(trifluoromethanesulfonyl)imide, trimethyl hexylammonium-bis(trifluoromethanesulfonyl)imide, or trimethyl octylammonium-bis(trifluoromethanesulfonyl)imide.

6. The lithium secondary battery according to claim 1, wherein the nonvolatile liquid is 1-ethyl-3-methylimidazolium-bis(trifluoromethanesulfonyl)imide or 1-ethyl-3-methylimidazolium-bis(pentafluoroethanesulfonyl)imide.
